(19) United States
(12) Patent Application Publication
(10) Pub. No.: US 2012/0300043 A1
(43) Pub. Date: Nov. 29, 2012

(54) STEREOSCOPIC IMAGE DISPLAY DEVICE

(75) Inventor: Takayoshi URISU, Osaka (JP)

(73) Assignee: FUNAI ELECTRIC CO., LTD., Osaka (JP)

(21) Appl. No.: 13/456,223

(22) Filed: Apr. 26, 2012

(30) Foreign Application Priority Data
May 24, 2011 (JP) 2011-115590

(51) Int. Cl. H04N 13/04

(52) U.S. Cl. 348/51; 348/E13.026

(57) ABSTRACT

The present invention discloses a stereoscopic image display device includes a first image processing chip, a second image processing chip and a format reception unit. The first image processing chip carries out image processing on a 3D image including a frame image in which an image for left eye and an image for right eye are combined. The second image processing chip reproduces the image for left eye and the image for right eye from the 3D image. The first image processing chip has an OSD section that superimposes an OSD image to the frame image. The second image processing chip reproduces the image for left eye by using an image acquired from a combined area of the image for left eye that is defined in the output format received by a format reception unit and reproduces the image for right eye by using an image acquired from a combined area of the image for right eye that is defined in the output format received by the format reception unit. The OSD section superimposes the OSD image to a position according to the output format received by the format reception unit.

### CROSS-REFERENCES TO RELATED APPLICATIONS

The present application is related to the Japanese Patent Application No. 2011-115590, filed May 24, 2011, the entire disclosure of which is expressly incorporated by reference herein.

### BACKGROUND OF THE INVENTION

1. Field of the Invention

The present invention relates to a stereoscopic image display device that carries out a process of reproducing an image for left eye and an image for right eye from a 3D (3-Dimensional) image in which both images for left eye and right eye are combined.

2. Description of the Related Art

There are various formats for the image of a 3D television. Technologies for displaying images and converting formats concerning the 3D television are disclosed in the following documents:
Japanese Patent Application Publication 2010-258848
Japanese Patent Application Publication 2010-288234
Japanese Patent Application Publication 2004-343290
Japanese Patent Application Publication 2010-028456

For example, the 3D television is composed of two chips: a SoC (System on Chip) that carries out various image processing such as a brightness control and a contrast control, and a FRC (Frame Rate Converter) that converts a frame rate. The SoC superimposes an OSD (On Screen Display) image on the image. As for the 3D television, 3D images having a format such as a Side by Side format (hereafter abbreviated as SbyS), a Top & Bottom format (hereafter abbreviated as T&B), and an HDMI 1.4 Frame Packing format (hereafter abbreviated as HDMI) are input.

If a user sets a wrong 3D output mode, the user cannot view the 3D images and the OSD (On Screen Display) images. Accordingly, the user may not be able to exit from the wrong setting of the 3D output mode.

### BRIEF SUMMARY OF THE INVENTION

The present invention discloses a stereoscopic image display device that enables the user to view the OSD images even when the setting of the 3D output mode is wrongly set.

One aspect of the present invention provides a stereoscopic image display device, comprising:

a first image processing chip that carries out image processing on a 3D (3-Dimensional) image including a frame image in which an image for left eye and an image for right eye are combined;

a second image processing chip that reproduces the image for left eye and the image for right eye from the 3D image; and

a format reception unit that receives a selection of an output format of the 3D image;

wherein

the first image processing chip has an OSD section that superimposes an OSD (On Screen Display) image to the frame image;

the second image processing chip reproduces the image for left eye by using an image acquired from a combined area of the image for left eye that is defined in the output format received by the format reception unit and reproduces the image for right eye by using an image acquired from a combined area of the image for right eye that is defined in the output format received by the format reception unit; and

the OSD section superimposes the OSD image to a position according to the output format received by the format reception unit.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

FIG. 1 is an exemplary illustration of a block diagram showing main sections of a 3D television.

FIG. 2 is an example of a 3D output mode setting screen.

FIG. 3 is an exemplary illustration that explains a case when an input format is the T&B while an output format is the SbyS.

FIG. 4 is an exemplary illustration that explains a case when an input format is the SbyS while an output format is the T&B.

FIG. 5 is an exemplary illustration that explains a case when an input format is the HDMI while an output format is the SbyS.

FIG. 6 is an exemplary illustration that explains a case when an input format is the HDMI while an output format is the T&B.

FIG. 7 is an exemplary illustration that explains an image processing of the SbyS.

FIG. 8 is an exemplary illustration that explains an image processing of the T&B.

FIG. 9 is an exemplary illustration that explains an image processing of the HDMI.

FIG. 10 is an exemplary illustration that explains a comparative example when an input 3D image is the T&B while the setting of the 3D output mode is set to the SbyS.

FIG. 11 is an exemplary illustration that explains a comparative example when an input 3D image is the SbyS while the setting of the 3D output mode is set to the T&B.

FIG. 12 is an exemplary illustration that explains a comparative example when an input 3D image is the HDMI while the setting of the 3D output mode is set to the SbyS.

FIG. 13 is an exemplary illustration that explains a comparative example when an input 3D image is the HDMI while the setting of the 3D output mode is set to the T&B.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

An embodiment of the present invention will be described below. It goes without saying that the below-described embodiment merely exemplifies the present invention.

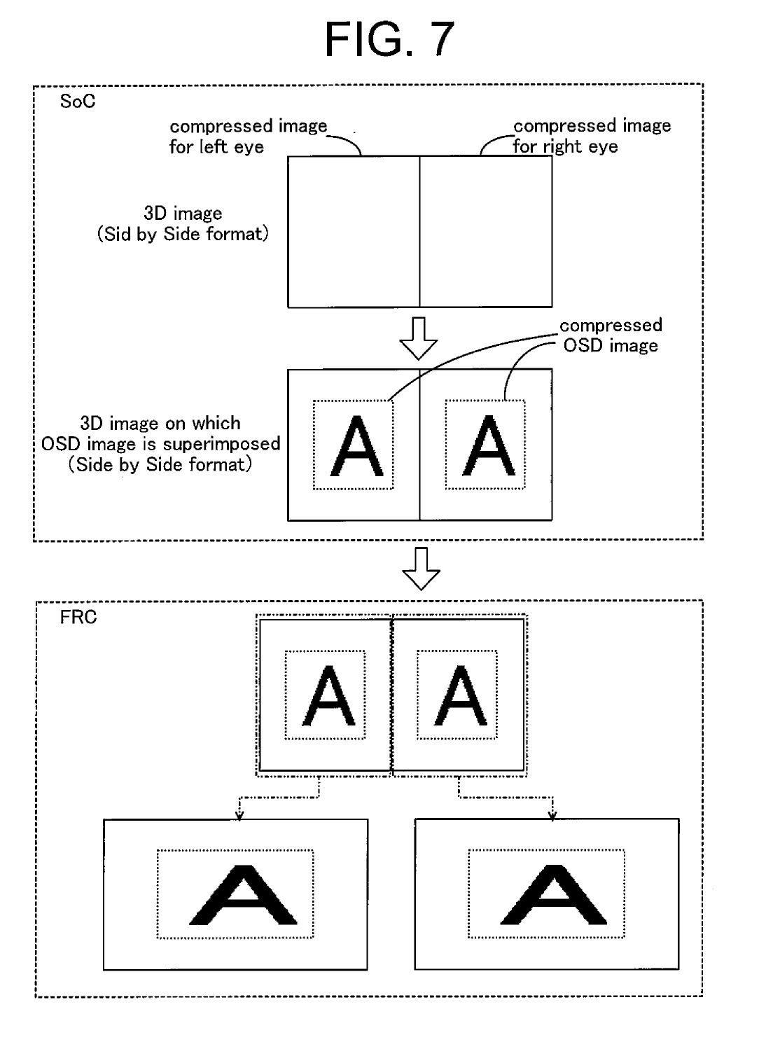

FIG. 7 is an exemplary illustration that explains an image processing of the SbyS. As shown in FIG. 7, in a 3D image of the SbyS, a frame image (hereafter SbyS frame image) is composed by horizontally aligning a compressed image for left eye that is compressed to half width and a compressed image for right eye that is compressed to half width. The SoC carries out various image processing to the frame image and then outputs the frame image to the FRC.

If the SoC is instructed to superimpose the OSD image while inputting the SbyS frame image, the SoC generates a compressed OSD image that is compressed to half width. The SoC superimposes the compressed OSD image to a predefined position of the compressed image for left eye and a predefined position of the compressed image for right eye respectively, and then outputs the SbyS frame image on which the OSD image is superimposed to the FRC.

The FRC reproduces the image for left eye by clipping the left half of the SbyS frame image and doubling the width of it, and reproduces the image for right eye by clipping the right half of the SbyS frame image and doubling the width of it. The reproduced images for left eye and for right eye are output alternately in an active system. On the other hand, the reproduced images are divided into horizontal lines and then odd/even lines are aligned and output to left/right eyes respectively in a passive system.

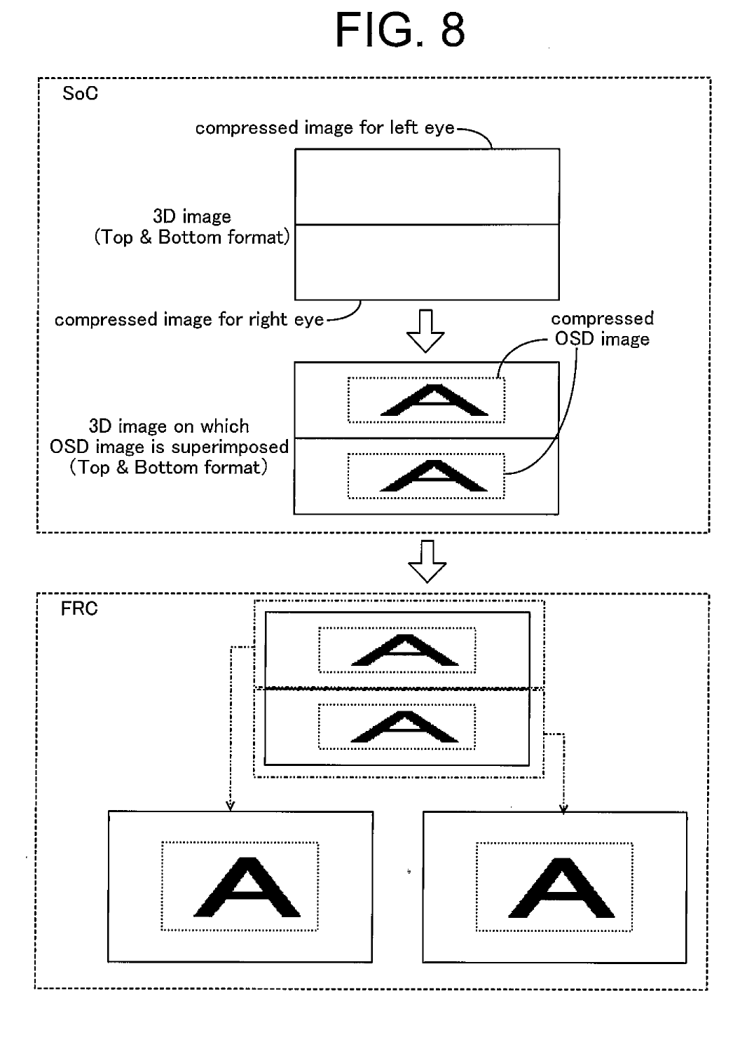

FIG. 8 is an exemplary illustration that explains an image processing of the T&B. As shown in FIG. 8, in a 3D image of the T&B, a frame image (hereafter T&B frame image) is composed by vertically aligning a compressed image for left eye that is compressed to half height and a compressed image for right eye that is compressed to half height. The SoC carries out various image processing to the frame image and then outputs the frame image to the FRC.

If the SoC is instructed to superimpose the compressed OSD image while inputting the T&B frame image, the SoC generates a compressed OSD that is compressed to half height. The SoC superimposes the compressed OSD image to a predefined position of the compressed image for left eye and a predefined position of the compressed image for right eye respectively, and then outputs the T&B frame image on which the OSD image is superimposed to the FRC.

The FRC reproduces the image for left eye by clipping the upper half of the T&B frame image and doubling the height of it, and reproduces the image for right eye by clipping the lower half of the T&B frame image and doubling the height of it. The reproduced images for left eye and for right eye are output alternately in an active system. On the other hand, the reproduced images are divided into horizontal lines and then odd/even lines are aligned and output to left/right eyes respectively in a passive system.

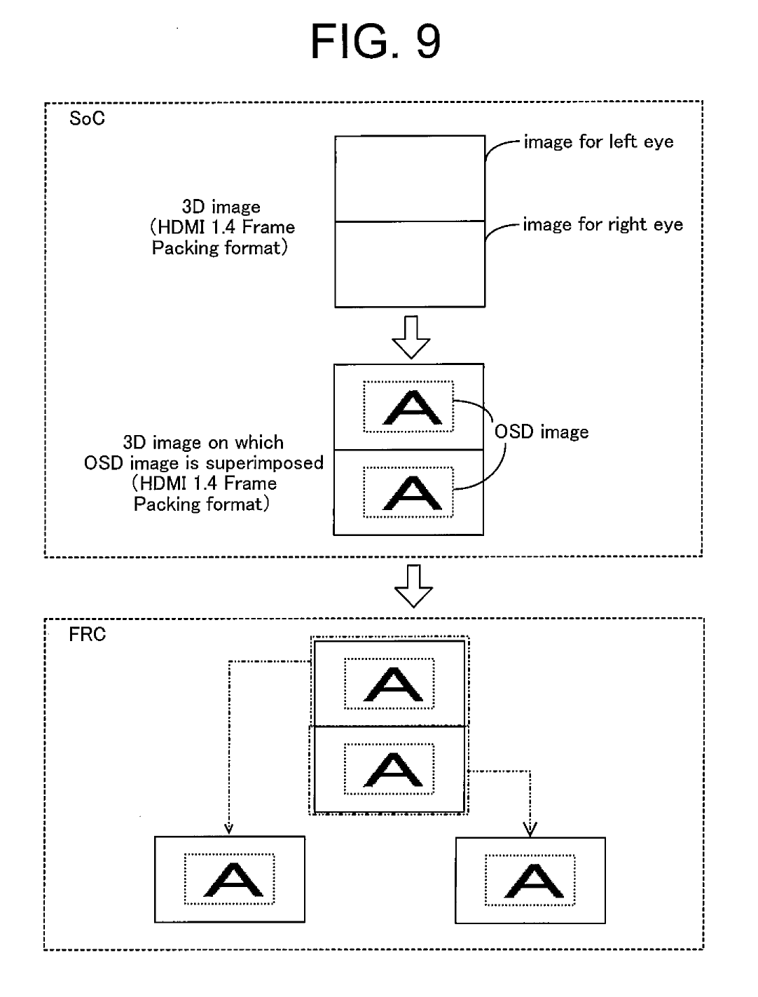

FIG. 9 is an exemplary illustration that explains an image processing of the HDMI. As shown in FIG. 9, in a 3D image of the HDMI, a frame image (hereafter HDMI frame image) is composed by vertically aligning an image for left eye that has a normal height and an image for right eye that has a normal height. Consequently, the height of the HDMI frame image is doubled as normal. The SoC carries out various image processing to the frame image and then outputs the frame image to the FRC.

If the SoC is instructed to superimpose the OSD image while inputting the HDMI frame image, the SoC generates the OSD image, then superimposes the OSD image on a predefined position of the image for left eye and a predefined position of the image for right eye respectively, and then outputs the HDMI frame image on which the OSD image is superimposed to the FRC.

The FRC reproduces the image for left eye by clipping the upper half of the HDMI frame image, and reproduces the image for right eye by clipping the lower half of the HDMI frame image. The reproduced images for left eye and for right eye are output alternately in an active system. On the other hand, the reproduced images are divided into horizontal lines and then odd/even lines are aligned and output to left/right eyes respectively in a passive system.

Here, the SoC has a means to judge the format of the input 3D image (SbyS, T&B, or HDMI), and thus the SoC can superimpose the OSD image on the appropriate position according to the format of the input 3D image. The FRC generates the image for left eye and the image for right eye according to the setting of the 3D output mode input from the user by using an operating section such as a remote controller. In other words, if the 3D output mode is set to the SbyS, the FRC reproduces the image for left eye by clipping the left half of the frame image and doubling the width of it, and reproduces the image for right eye by clipping the right half of the frame image and doubling the width of it. In addition, if the 3D output mode is set to the T&B, the FRC reproduces the image for left eye by clipping the upper half of the frame image and doubling the height of it, and reproduces the image for right eye by clipping the lower half of the frame image and doubling the height of it.

Accordingly, if the setting of the 3D output mode is wrongly set against the correct format of the input 3D image, the following problems may be occurred.

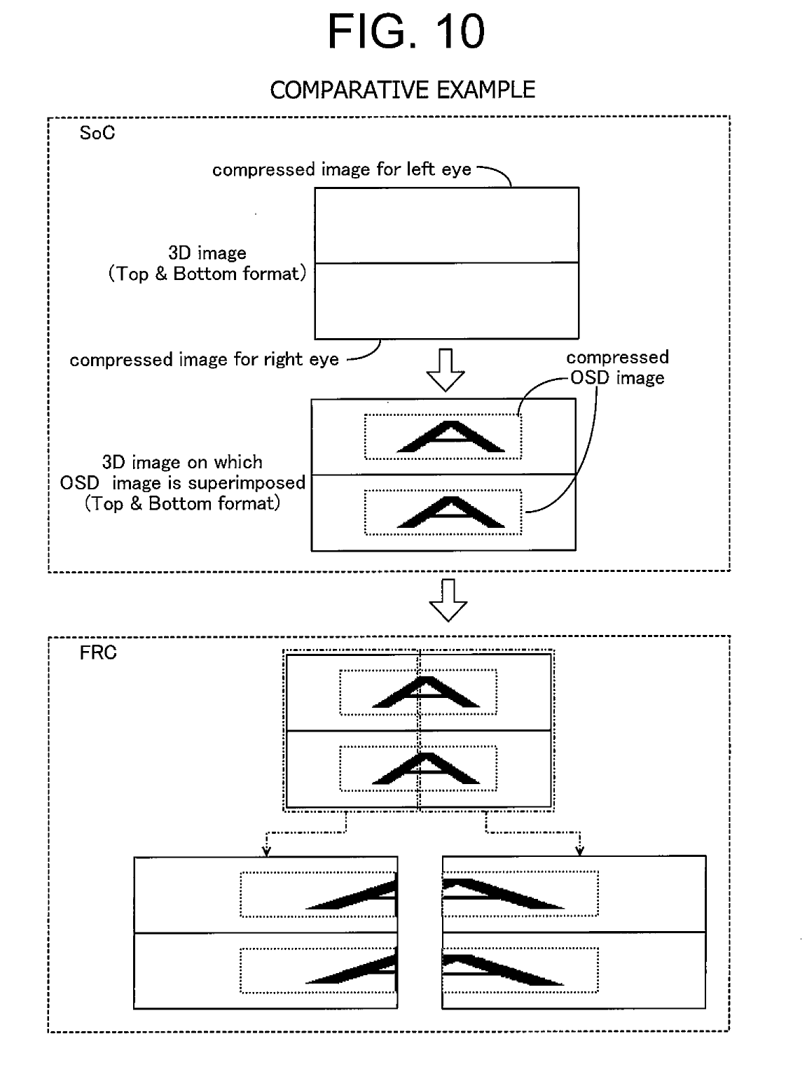

FIG. 10 is an exemplary illustration that explains a comparative example when the input 3D image is the T&B while the setting of the 3D output mode is set to the SbyS. As shown in FIG. 10, the SoC superimposes the OSD image on an appropriate position of the compressed image for left eye and the compressed image for right eye. However, the FRC reproduces the image for left eye by clipping the left half of the T&B frame image and doubling the width of it, and reproduces the image for right eye by clipping the right half of the T&B frame image and doubling the width of it. Accordingly, the 3D image and the OSD image are not properly displayed on the screen and cannot be viewed. In other words, the user cannot understand the content of the OSD image or the like.

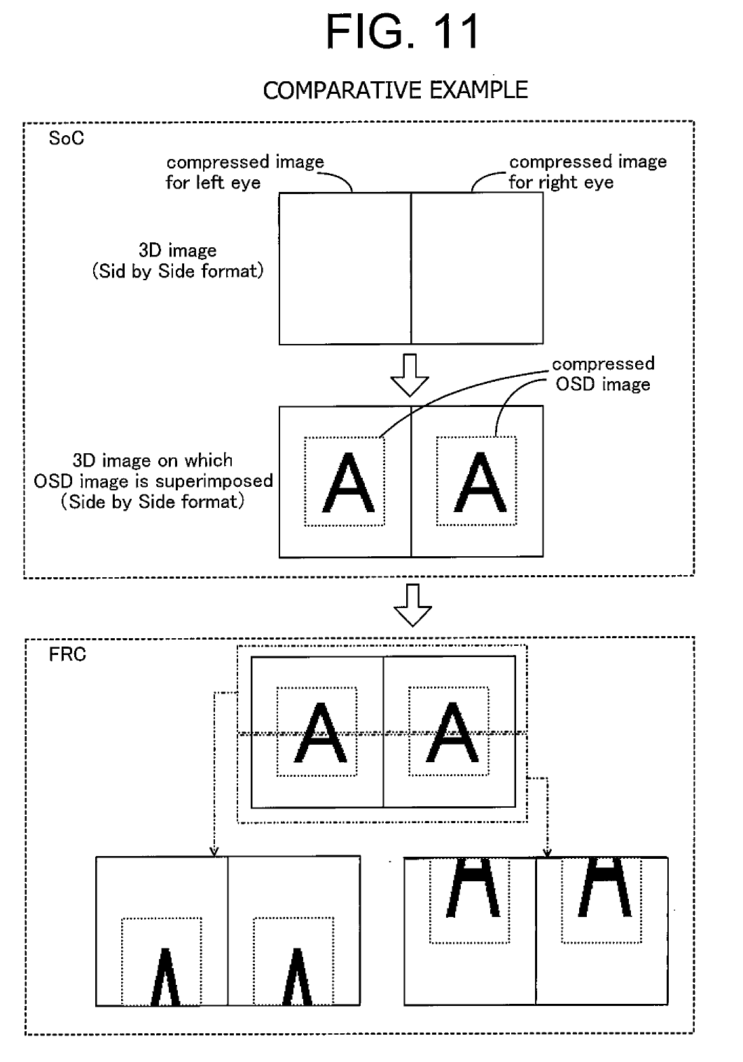

FIG. 11 is an exemplary illustration that explains a comparative example when the input 3D image is the SbyS while the setting of the 3D output mode is set to the T&B. As shown in FIG. 11, the SoC superimposes the OSD image on an appropriate position of the compressed image for left eye and the compressed image for right eye. However, the FRC reproduces the image for left eye by clipping the upper half of the SbyS frame image and doubling the height of it, and reproduces the image for right eye by clipping the lower half of the SbyS frame image and doubling the height of it. Accordingly, the 3D image and the OSD image are not properly displayed on the screen and cannot be viewed.

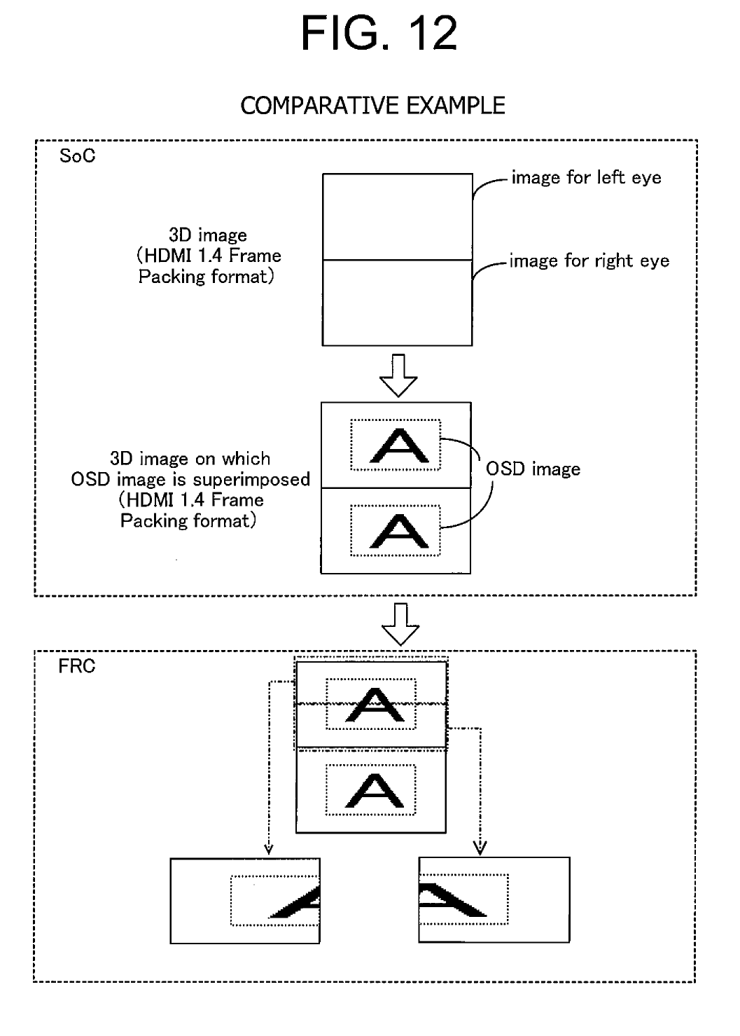

FIG. 12 is an exemplary illustration that explains a comparative example when the input 3D image is the HDMI while the setting of the 3D output mode is set to the SbyS. As shown in FIG. 12, the SoC superimposes the OSD image on an appropriate position of the image for left eye and the image for right eye. However, the FRC reproduces the image for left eye by clipping the left half of the upper half (image for left eye) of the HDMI frame image and doubling the width of it, and reproduces the image for right eye by clipping the right half of the upper half (image for left eye) of the HDMI frame image and doubling the width of it. Accordingly, the 3D image and the OSD image are not properly displayed on the screen and cannot be viewed.

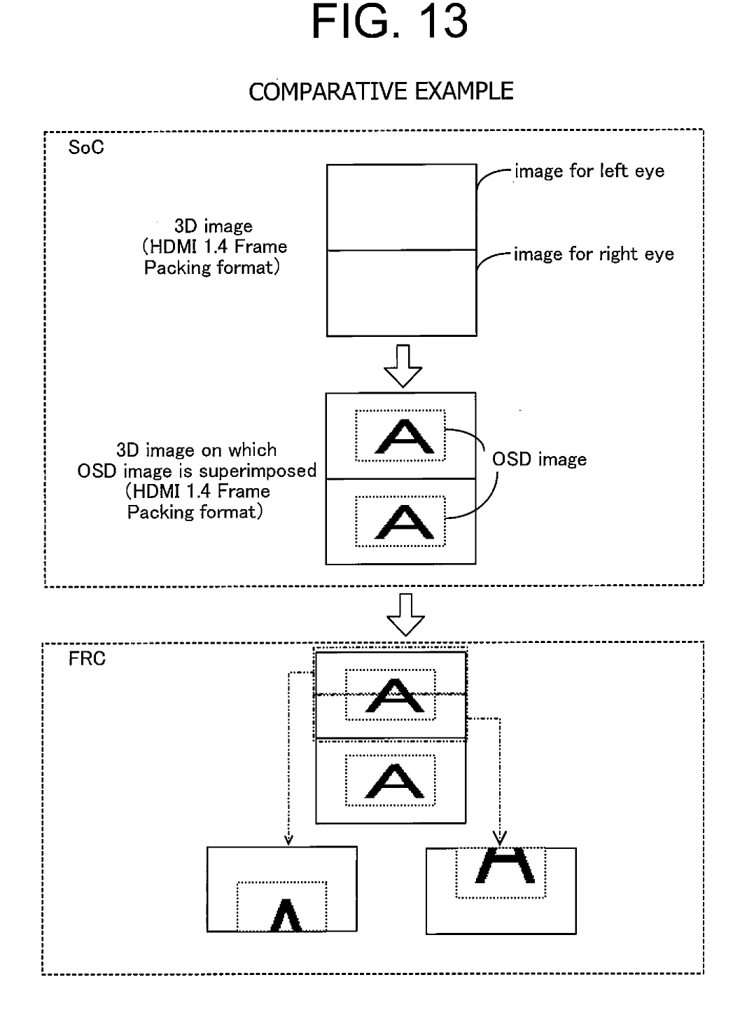

FIG. 13 is an exemplary illustration that explains a comparative example when the input 3D image is the HDMI while the setting of the 3D output mode is set to the T&B. As shown in FIG. 13, the SoC superimposes the OSD image on an appropriate position of the image for left eye and the image for right eye. However, the FRC reproduces the image for left eye by clipping the upper half of the upper half (image for left eye) of the HDMI frame image, and reproduces the image for right eye by clipping the lower half of the upper half (image for left eye) of the HDMI frame image. Accordingly, the 3D image and the OSD image are not properly displayed on the screen and cannot be viewed.

(First Aspect)

One aspect of the present invention provides a stereoscopic image display device, comprising:

a first image processing chip that carries out image processing on a 3D (3-Dimensional) image including a frame image in which an image for left eye and an image for right eye are combined;

a second image processing chip that reproduces the image for left eye and the image for right eye from the 3D image; and

a format reception unit that receives a selection of an output format of the 3D image;

wherein

the first image processing chip has an OSD section that superimposes an OSD (On Screen Display) image to the frame image;

the second image processing chip reproduces the image for left eye by using an image acquired from a combined area of the image for left eye that is defined in the output format received by the format reception unit and reproduces the image for right eye by using an image acquired from a combined area of the image for right eye that is defined in the output format received by the format reception unit; and

the OSD section superimposes the OSD image to a position according to the output format received by the format reception unit.

According to the first aspect, the user can view the OSD image or understand the content of the OSD image even when the setting of the 3D output mode is wrongly set.

(Second Aspect)

Another aspect of the present invention provides a stereoscopic image display device, comprising:

a first image processing chip that carries out image processing on a 3D image including a frame image in which an image for left eye and an image for right eye are combined;

a second image processing chip that reproduces the image for left eye and the image for right eye respectively from the 3D image;

a format reception unit that receives a selection of an output format of the 3D image; and

an OSD section that is in the first image processing chip and superimposes an OSD image to the frame image;

wherein

the second image processing chip reproduces the image for left eye by using an image acquired from a combined area of the image for left eye that is defined in the output format received by the format reception unit and reproduces the image for right eye by using an image acquired from a combined area of the image for right eye that is defined in the output format received by the format reception unit; and

the OSD section superimposes the OSD image to a position according to the output format received by the format reception unit.

According to the second aspect, the user can view the OSD image or understand the content of the OSD image even when the setting of the 3D output mode is wrongly set.

(Third Aspect)

An optional aspect of the present invention provides the stereoscopic image display device, wherein:

when the format reception unit receives the selection of a Side by Side format as the output format, the OSD section superimposes a compressed OSD image that is compressed to half width to a predefined position of a left half of the frame image and a predefined position of a right half of the frame image.

According to the third aspect, the user can view the OSD image even when the setting of the 3D output mode is wrongly set in case the output format is the Side by Side format.

(Fourth Aspect)

Another optional aspect of the present invention provides the stereoscopic image display device, wherein:

when the format reception unit receives the selection of a Top & Bottom format as the output format, the OSD section superimposes a compressed OSD image that is compressed to half height to a predefined position of an upper half of the frame image and a predefined position of a lower half of the frame image.

According to the fourth aspect, the user can view the OSD image even when the setting of the 3D output mode is wrongly set in case the output format is the Top & Bottom format.

Note that the above described stereoscopic image display device can also be achieved in various ways, by being built into another device or by being carried out together with other methods, for example. In addition, the present invention can also be achieved as a stereoscopic image display system having the above described stereoscopic image display device, a method having the process corresponding to the above described device, a program to let the computer carry out the function corresponding to the above described device, or a computer readable recording media that records the program. The stereoscopic image display system, the method for displaying stereoscopic image, the program for displaying stereoscopic image, and the recording media for displaying stereoscopic image has same functions and effects as the above described device.

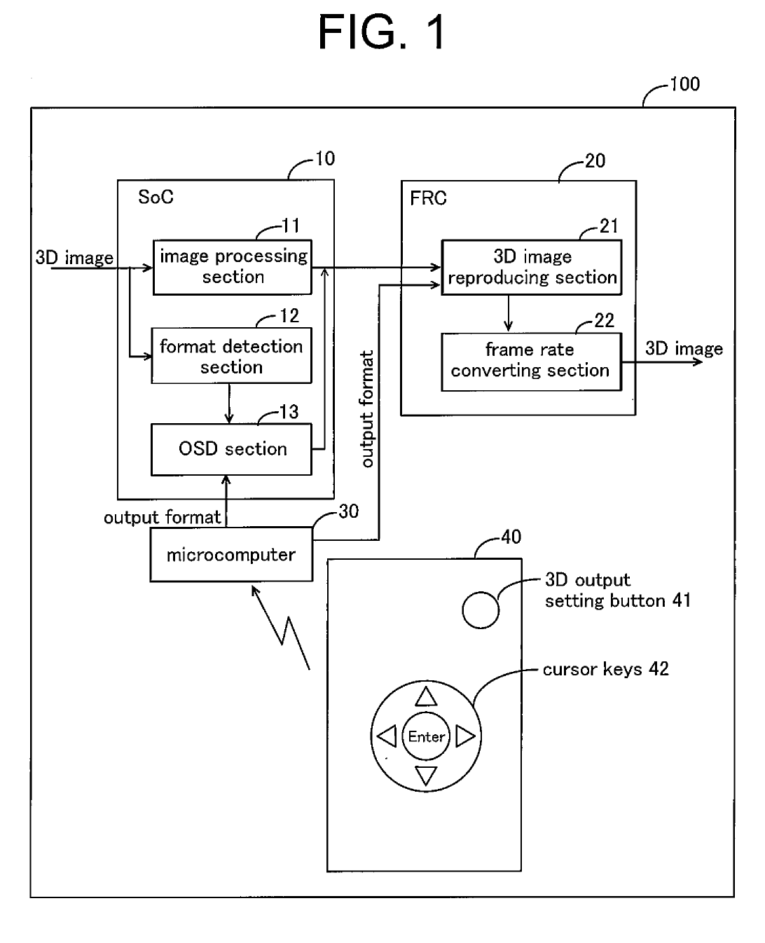

FIG. 1 is an exemplary illustration of a block diagram showing main sections of a 3D television (stereoscopic image display device). The 3D television has a SoC (System on Chip) 10, a FRC (Frame Rate Converter) 20, a microcomputer 30, and a remote controller 40. Here, the SoC 10 is an example of a first image processing chip. The FRC 20 is an example of a second image processing chip. The remote controller 40 is an example of a format reception unit.

The SoC 10 has an image processing section 11, a format detection section 12, and an OSD section 13. The SoC inputs 3D (3-Dimensional) images and 2D (2-Dimensional) images, and carries out various processes without converting the frame rate (e.g. 60 Hz) of the input image. The image processing section 11 carries out various image processing such as the brightness control and a contrast control on the 3D images and 2D images input to the SoC 10. The format detection section 12 acquires tags transmitted during a vertical interval or tags of HDMI InfoFrame, then judges the format of the input image based on the acquired tag information. The OSD section 13 superimposes the OSD images on each frame image of the input image according to the instruction of the microcomputer 30.

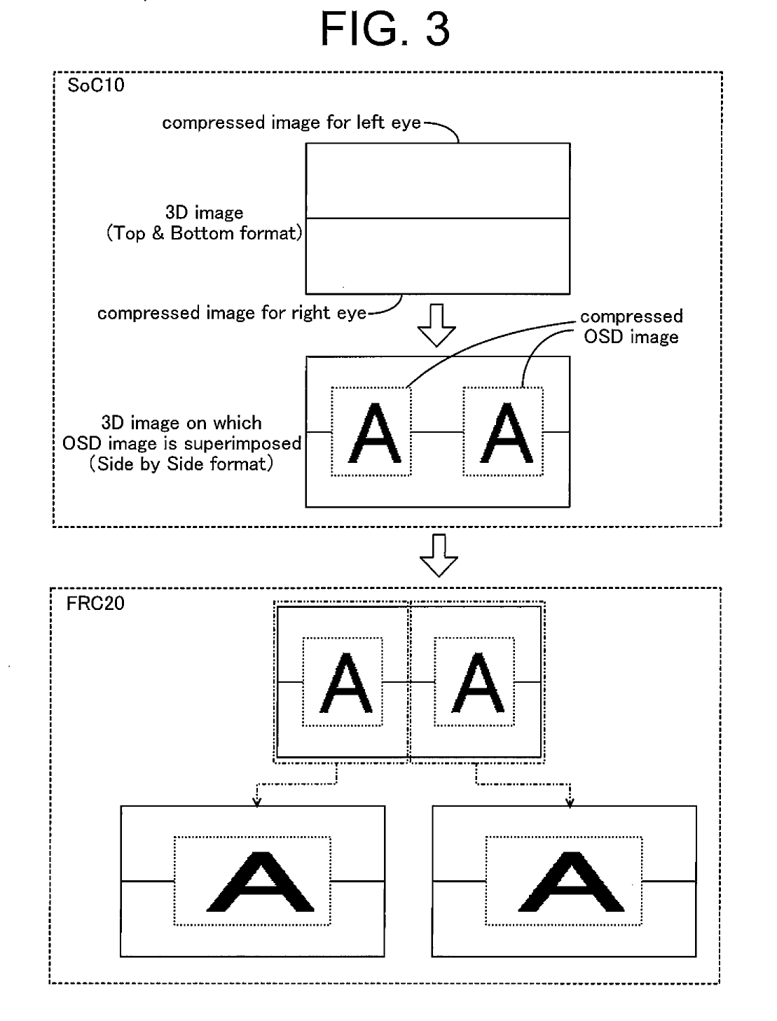

The FRC 20 has a 3D image reproducing section 21 and a frame rate converting section 22. As explained referring to FIGS. 3 to 9, the 3D image reproducing section 21 reproduces the image for left eye and the image for right eye from the frame image on which both images for left eye and right eye are combined, and then sequentially outputs them to the frame rate converting section 22. Note that the 3D image reproducing section 21 outputs the image to the frame rate converting section 22 without executing any processes if the input image is the 2D image.

The microcomputer 30 controls whole the 3D television 100. The remote controller 40 has a 3D output setting button 41 to set the 3D output format in addition to a power button, channel switching buttons, cursor keys 42 and other buttons. The microcomputer 30 has a remote control signal reception section that receives remote control signals output from the remote controller 40, and carries out processes according to the received remote control signals. For example, if the microcomputer 30 receives a signal to indicate the operation of the 3D output setting button 41, the microcomputer 30 instructs the OSD section 13 to display the OSD image concerning the 3D output mode setting screen to select the setting of the 3D output mode.

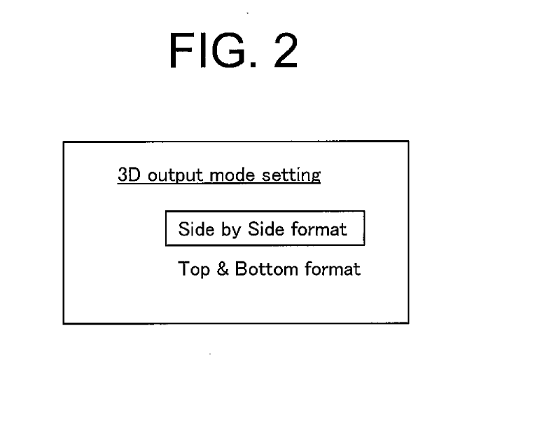

FIG. 2 is an example of the 3D output mode setting screen. In the 3D output mode setting screen shown in FIG. 2, “Side by Side format” or “Top & Bottom format” is selectable as the 3D output mode. The user can select one of the 3D output modes by operating up/down keys of the cursor keys 42 to align the cursor and operating the Enter key. Hereafter, the 3D format corresponding to the 3D output mode selected by the remote controller 40 by the user is described as “output format”. On the other hand, the 3D format concerning the 3D image actually input is described as “input format”.

The 3D image reproducing section 21 receives the information concerning the output format from the microcomputer 30, and reproduces the 3D images according to the output format. In other words, the 3D image reproducing section 21 acquires images from the 3D image according to the combined area of the image for left eye and right eye that is defined in the output format, and then reproduces the images for left eye and right eye by enlarging the acquired image if the output format is the compressed format.

In addition, the OSD section 13 also receives the information concerning the output format from the microcomputer 30, and superimposes the OSD (On Screen Display) image on the 3D image according to the output format. In other words, the position to superimpose the OSD image is decided according to the output format without depending on the input format. Hereafter, a relation between the superposition of the OSD screen and the reproduction of the 3D image is explained in connection with a combination of the input format and the output format.

At first, in case the input format is the SbyS and the output format is the SbyS, the OSD section 13 superimposes the compressed OSD image that is compressed to half width based on the output format (SbyS) to a predefined position of the left half of the frame image and a predefined position of the right half of the frame image. The FRC 20 reproduces the image for left eye by clipping the left half of the frame image on which the OSD image is superimposed and doubling the width of it, and reproduces the image for right eye by clipping the right half of the frame image on which the OSD image is superimposed and doubling the width of it. Accordingly, same as the case described in FIG. 7, the original 3D image is reproduced with the OSD image is superimposed on an appropriate position, and thus an appropriate 3D image on which the OSD image is superimposed can be displayed on the screen.

In case the input format is the T&B and the output format is the T&B, the OSD section 13 superimposes the compressed OSD image that is compressed to half height based on the output format (T&B) to a predefined position of the upper half of the frame image and a predefined position of the lower half of the frame image. The FRC 20 reproduces the image for left eye by clipping the upper half of the frame image on which the OSD image is superimposed and doubling the height of it, and reproduces the image for right eye by clipping the lower half of the frame image on which the OSD image is superimposed and doubling the height of it. Accordingly, same as the case described in FIG. 8, the original 3D image is reproduced with the OSD image is superimposed on an appropriate position, and thus an appropriate 3D image on which the OSD image is superimposed can be displayed on the screen.

In case the input format is the HDMI and the output format is the HDMI, the OSD section 13 superimposes the OSD image that is not compressed based on the output format (HDMI) to a predefined position of the upper half of the frame image and a predefined position of the lower half of the frame image. The FRC 20 reproduces the image for left eye by clipping the upper half of the frame image on which the OSD image is superimposed, and reproduces the image for right eye by clipping the lower half of the frame image on which the OSD image is superimposed. Accordingly, same as the case described in FIG. 9, the original 3D image is reproduced with the OSD image is superimposed on an appropriate position, and thus an appropriate 3D image on which the OSD image is superimposed can be displayed on the screen.

Then, referring to FIG. 3, a case the input format is the T&B and the output format is the SbyS is explained. As shown in FIG. 3, although the upper half of the frame image is the compressed image for left eye and the lower half of the frame image is the compressed image for right eye in the input format, the OSD section 13 judges the frame image as the SbyS based on the output format, and then superimposes the compressed OSD image that is compressed to half width to a predefined position of the left half of the frame image and a predefined position of the right half of the frame image.

The FRC 20 reproduces the image for left eye by clipping the left half of the frame image and doubling the width of it, and reproduces the image for right eye by clipping the right half of the frame image and doubling the width of it. At that time, the 3D image is not displayed on the screen because the original 3D image is not reproduced. However the OSD image is displayed on an appropriate position of the screen because the OSD image is superimposed on an appropriate position of the image for left eye and the image for right eye. Accordingly, after the user recognized the wrong setting of the output format, the user can switch the setting of the 3D output mode by operating the 3D output setting button 41 because the OSD screen concerning 3D output mode setting screen can be displayed properly on the screen.

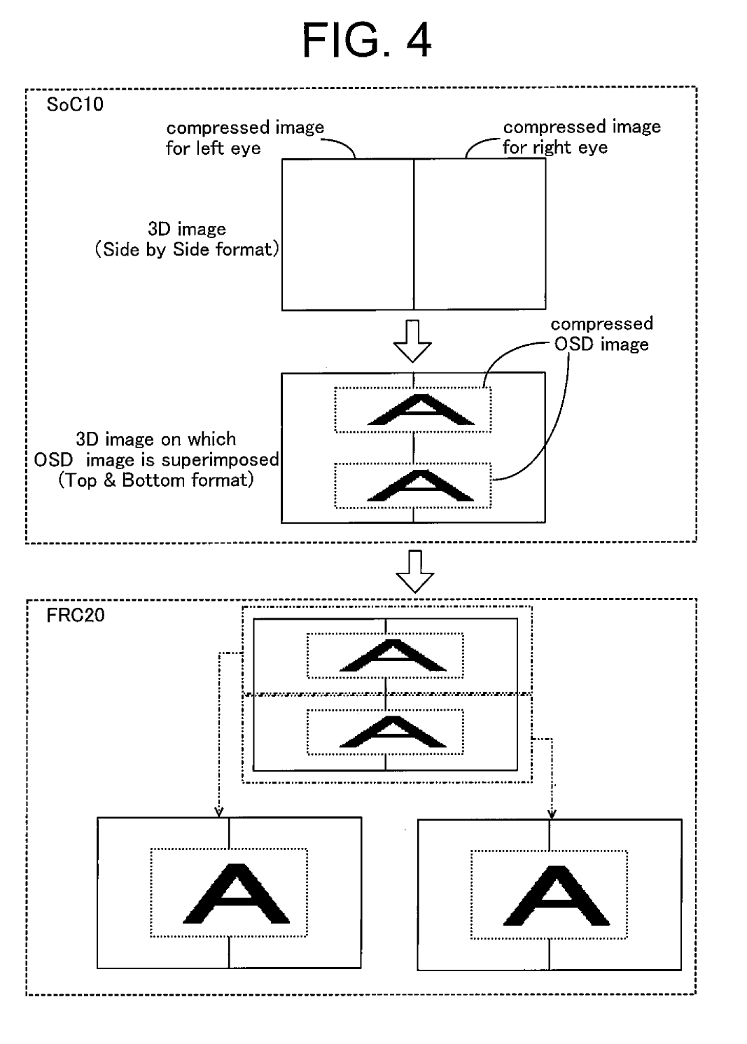

Then, referring to FIG. 4, a case the input format is the SbyS and the output format is the T&B is explained. As shown in FIG. 4, although the left half of the frame image is the compressed image for left eye and the right half of the frame image is the compressed image for right eye in the input format, the OSD section 13 judges the frame image as the T&B based on the output format, and then superimposes the compressed OSD image that is compressed to half height to a predefined position of the upper half of the frame image and a predefined position of the lower half of the frame image.

The FRC 20 reproduces the image for left eye by clipping the upper half of the frame image and doubling the height of it, and reproduces the image for right eye by clipping the lower half of the frame image and doubling the height of it. At that time, the 3D image is not displayed on the screen because the original 3D image is not reproduced. However the OSD image is displayed on an appropriate position of the screen because the OSD image is superimposed on an appropriate position of the image for left eye and the image for right eye. Accordingly, after the user recognized the wrong setting of the output format, the user can switch the setting of the 3D output mode by operating the 3D output setting button 41 because the OSD screen concerning 3D output mode setting screen can be displayed properly on the screen.

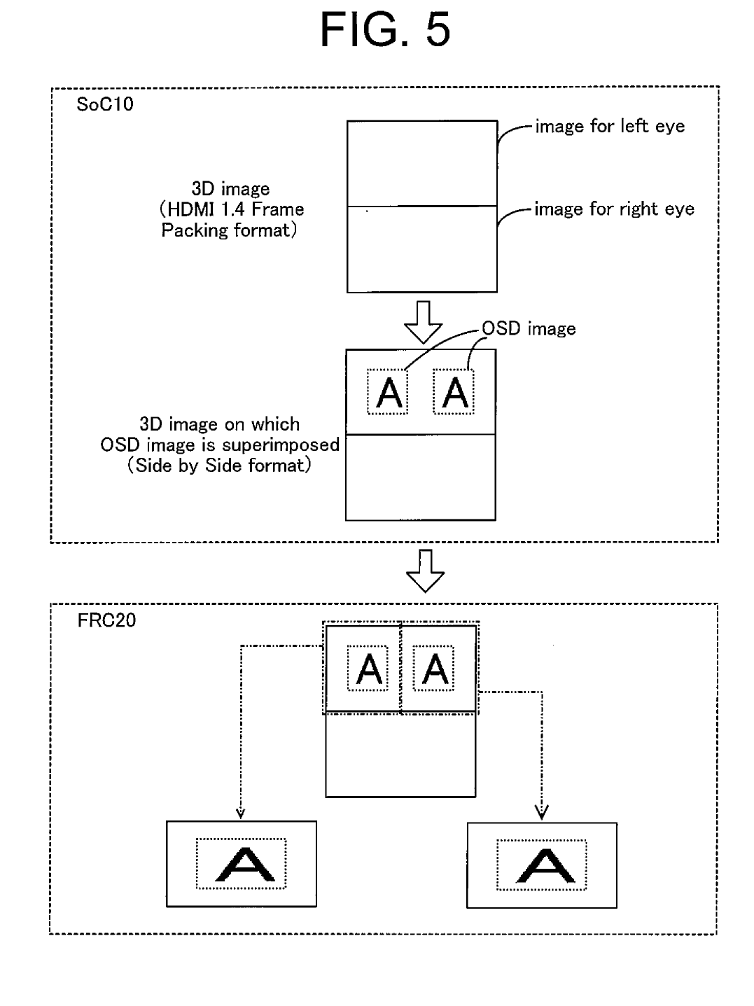

Then, referring to FIG. 5, a case the input format is the HDMI and the output format is the SbyS is explained. As shown in FIG. 5, although the upper half of the frame image is the image for left eye and the lower half of the frame image is the image for right eye and the height of the total frame image is doubled as normal in the input format, the OSD section 13 judges the frame image as the SbyS based on the output format, and then superimposes the compressed OSD image that is compressed to half width to a predefined position of the left half of the upper half of the frame image and a predefined position of the right half of the upper half of the frame image.

The FRC 20 reproduces the image for left eye by clipping the left half of the upper half of the frame image and doubling the width of it, and reproduces the image for right eye by clipping the right half of the upper half of the frame image and doubling the width of it. At that time, the 3D image is not displayed on the screen because the original 3D image is not reproduced. However the OSD image is displayed on an appropriate position of the screen because the OSD image is superimposed on an appropriate position of the image for left eye and the image for right eye. Accordingly, after the user recognized the wrong setting of the output format, the user can switch the setting of the 3D output mode by operating the 3D output setting button 41 because the OSD screen concerning 3D output mode setting screen can be displayed properly on the screen.

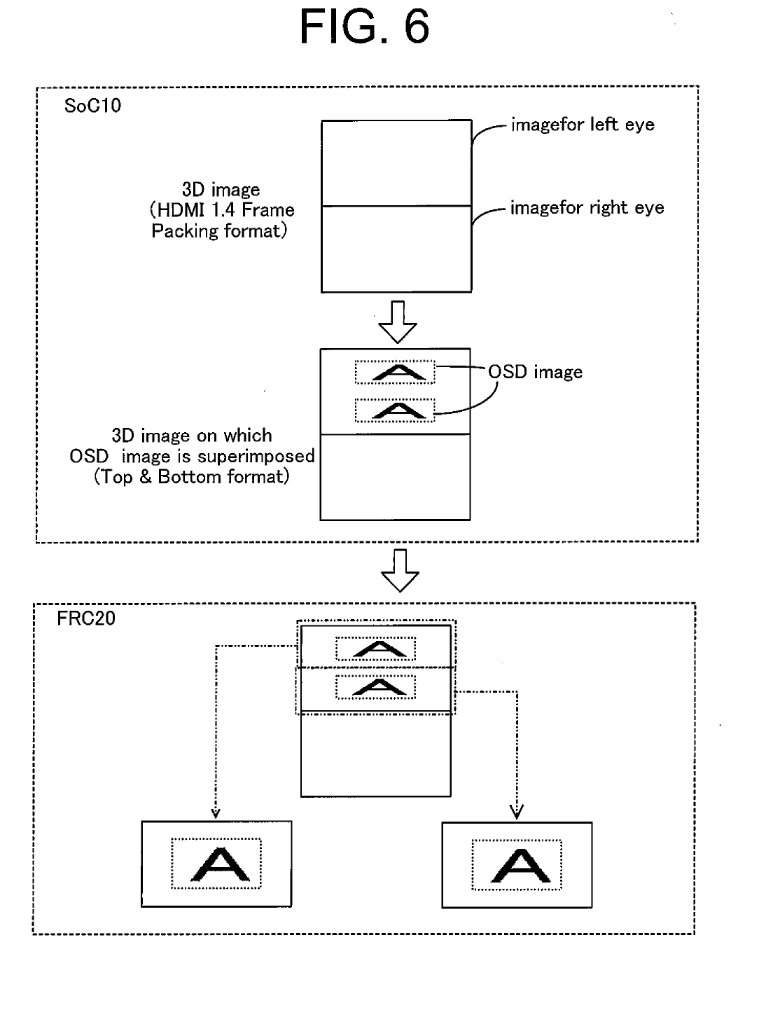

Then, referring to FIG. 6, a case the input format is the HDMI and the output format is the T&B is explained. As shown in FIG. 6, although the upper half of the frame image is the image for left eye and the lower half of the frame image is the image for right eye and the height of the total frame image is doubled as normal in the input format, the OSD section 13 judges the frame image as the T&B based on the output format, and then superimposes the compressed OSD image that is compressed to half height to a predefined position of the upper half of the upper half of the frame image and a predefined position of the lower half of the upper half of the frame image.

The FRC 20 reproduces the image for left eye by clipping the upper half of the upper half of the frame image and doubling the height of it, and reproduces the image for right eye by clipping the lower half of the upper half of the frame image and doubling the height of it. At that time, the 3D image is not displayed on the screen because the original 3D image is not reproduced. However the OSD image is displayed on an appropriate position of the screen because the OSD image is superimposed on an appropriate position of the image for left eye and the image for right eye. Accordingly, after the user recognized the wrong setting of the output format, the user can switch the setting of the 3D output mode by operating the 3D output setting button 41 because the OSD screen concerning 3D output mode setting screen can be displayed properly on the screen.

As explained above, the stereoscopic image display device in the present embodiment has the remote controller 40 having the 3D output setting button 41 to receive the instruction from the user to switch the setting of the output format of the 3D image and the SoC 10 having the OSD section 13 to superimpose the OSD (On Screen Display) image to the frame image, reproduces the image for left eye by using the image acquired from the combined area of the image for left eye that is defined in the output format, reproduces the image for right eye by using the image acquired from the combined area of the image for right eye that is defined in the output format, and superimposes the OSD image to the position according to the output format. Accordingly, the user can view the OSD image even when the setting of the 3D output mode is wrongly set.

In the above explained embodiment, the OSD section 13 compresses the OSD image and superimposes the OSD image on an appropriate position by the instruction of the microcomputer 30. However, the microcomputer 30 can preliminary compress the OSD image by judging the appropriate position and necessity of the compression based on the output format, and then instruct the OSD section 13 to superimpose the compressed OSD image on the predefined position.

In addition, the above-described basic operation and effect can be obtained even with the apparatus, the method and so on having only the features set forth in the independent claims and having no features set forth in the dependent claims.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. A stereoscopic image display device, comprising:
a first image processing chip that carries out image processing on a 3D (3-Dimensional) image including a frame image in which an image for left eye and an image for right eye are combined;
a second image processing chip that reproduces the image for left eye and the image for right eye from the 3D image; and
a format reception unit that receives a selection of an output format of the 3D image;
wherein
the first image processing chip has an OSD section that superimposes an OSD (On Screen Display) image to the frame image;
the second image processing chip reproduces the image for left eye by using an image acquired from a combined area of the image for left eye that is defined in the output format received by the format reception unit and reproduces the image for right eye by using an image acquired from a combined area of the image for right eye that is defined in the output format received by the format reception unit; and
the OSD section superimposes the OSD image to a position according to the output format received by the format reception unit.

2. The stereoscopic image display device according to claim 1, wherein:
when the format reception unit receives the selection of a Side by Side format as the output format, the OSD section superimposes a compressed OSD image that is compressed to half width to a predefined position of a left half of the frame image and a predefined position of a right half of the frame image.

3. The stereoscopic image display device according to claim 1, wherein:
when the format reception unit receives the selection of a Top & Bottom format as the output format, the OSD section superimposes a compressed OSD image that is compressed to half height to a predefined position of an upper half of the frame image and a predefined position of a lower half of the frame image.

4. A 3D television comprising:
a first image processing chip that inputs a 3D (3-Dimensional) image including a frame image in which an image for left eye and an image for right eye are combined according to a predefined format of the 3D image including a Side by Side format and a Top & Bottom format and then carries out an image processing on the 3D image;
a second image processing chip that reproduces the image for left eye and the image for right eye from the 3D image on which the image processing is carried out; and
a format reception unit that receives a selection of one of an output format of the 3D image including the Side by Side format and the Top & Bottom format;
wherein
the first image processing chip has an OSD section that superimposes an OSD (On Screen Display) image to the frame image;
when the format reception unit receives the selection of the Side by Side as the output format, the second image processing chip reproduces the image for left eye by using an image acquired from a combined area of the image for left eye that is defined in the output format of the Side by Side format and reproduces the image for right eye by using an image acquired from a combined area of the image for right eye that is defined in the output format of the Side by Side format;
when the format reception unit receives the selection of the Top & Bottom as the output format, the second image processing chip reproduces the image for left eye by using an image acquired from a combined area of the image for left eye that is defined in the output format of the Top & Bottom format and reproduces the image for right eye by using an image acquired from a combined area of the image for right eye that is defined in the output format of the Top & Bottom format;
when the format reception unit receives the selection of the Side by Side as the output format, the OSD section superimposes a compressed OSD image that is compressed to half width to a predefined position of a left half of the frame image and a predefined position of a right half of the frame image; and
when the format reception unit receives the selection of the Top & Bottom as the output format, the OSD section superimposes a compressed OSD image that is compressed to half height to a predefined position of an upper half of the frame image and a predefined position of a lower half of the frame image.
